(19) United States
(12) Patent Application Publication
(10) Pub. No.: US 2025/0323337 A1
(43) Pub. Date: Oct. 16, 2025

(54) SELECTIVE LITHIUM EXTRACTION FOR CATHODE MATERIALS

(71) Applicant: Worcester Polytechnic Institute, Worcester, MA (US)

(72) Inventors: Yan Wang, Acton, MA (US); Jiahui Hou, Worcester, MA (US); Zexin Wang, Worcester, MA (US)

(21) Appl. No.: 19/177,514

(22) Filed: Apr. 12, 2025

Related U.S. Application Data
(60) Provisional application No. 63/633,138, filed on Apr. 12, 2024.

(51) Int. Cl. H01M 10/54; C01D 7/24; C01D 15/08; C22B 3/00; C22B 3/22; C22B 3/44; C22B 7/00; C22B 26/12

(52) U.S. Cl. CPC H01M 10/54; C01D 7/24; C01D 15/08; C22B 3/22; C22B 3/44; C22B 7/006; C22B 23/0461; C22B 26/12

(57) ABSTRACT

Lithium recycling from expended Li-Ion batteries occurs thought selective recovery of lithium charge materials from a recycling stream including transition metals used for the charge material. Li recovery performed using an organic acid-based approach including terephthalic acid (TPA), benzenetetracarboxylic acid (BTCA), and other organic acids results in highly selective lithium extraction, achieving minimal transition metal contamination in the extracted solution. A recycling stream including cathode materials from spent/end-of-life Li-ion batteries provides a source for recycled Li, as well as other cathode material metals. Combining the organic acid in a hydrothermal reactor followed by filtration separates transition metal oxides from a lithium salt solution. The lithium salt may be recrystallized by acetone and dried to a powder consistency. Lithium carbonate is then recovered by sintering, and further filtered for recovering battery grade recycled Li.

### RELATED APPLICATIONS

This patent application claims the benefit under 35 U.S.C. § 119(e) of U.S. Provisional Patent App. No. 63/633,138, filed Apr. 12, 2024, entitled “SELECTIVE LITHIUM EXTRACTION FOR CATHODE MATERIALS,” incorporated herein by reference in entirety.

### BACKGROUND

The wide applications of lithium-ion batteries (LIBs) is driven by their superior performance in power sources, mobile electronics and energy storage devices. Moreover, LIBs dominate the electric vehicle market due to their high energy density. With the increasing demand of electric vehicles (EVs), a corresponding increase in spent LIB battery packs can be expected. Lithium is a finite natural resource primarily found in countries such as Chile, Australia, Argentina, and China. With the development of automotive electrification, the market for lithium-ion batteries has surged dramatically, Thus, sustainable LIBs systems will become increasingly beneficial.

### SUMMARY

An organic acid-based approach including terephthalic acid (TPA), benzenetetracarboxylic acid (BTCA), and other organic acids to perform highly selective lithium extraction, achieving minimal transition metal contamination in the extracted solution. A recycling stream including cathode materials from spent/end-of-life Li-ion batteries provides a source for recycled Li, as well as other cathode material metals. Combining the organic acid in a hydrothermal reactor followed by filtration separates transition metal oxides from a lithium salt solution. The lithium salt may be recrystallized by acetone and dried to a powder consistency. Lithium carbonate is then recovered by sintering, and further filtered for recovering battery grade recycled Li.

Configurations herein are based, in part, on the observation that secondary (rechargeable) batteries are becoming increasingly utilized for electrical based energy in a wide variety of commercial applications, such as portable devices (i.e. cellphones), battery powered tools and lighting, and more significantly, in EV (electric vehicles) and hybrid vehicles. The sheer battery mass required for vehicular application suggests that widespread use of EVs will generate considerable charge material waste streams amenable to recycling. Unfortunately, conventional recycling processes for battery waste streams often focus on the transition metals (Ni, Mn, Co, Cu and others), rather than lithium (Li), and tend to operate on pyrometallurgical processes that involve substantial heating that mitigates the energy savings, or uses hydrometallurgical processes that compromise purity.

Accordingly, configurations herein substantially overcome the shortcomings of high heat processes and impurities associated with conventional approaches by specifically targeting lithium in a recycling stream of Li-ion batteries, using a low temperature leach and solution approach that also preserves a parallel cathode material stream, such as for NMC (Nickel, Manganese, Cobalt) charge materials, and concurrently extracting highly pure battery grade lithium suitable for recycled Li-ion batteries.

In further detail, in a battery recycling environment a method for recycling lithium from a recycling stream of batteries includes receiving a recycling stream including cathode materials from a li-ion battery, and combining terephthalic acid (TPA) or other organic acid with the recycling stream in a pressure reactor. The pressure reactor is pressurized to a reactor pressure in a range between 1500 kPa-3000 kPa, and the resultant solution from the pressure reactor filtered to yield a lithium salt solution. Addition of a crystallizing agent to the lithium salt solution for recrystallizing, followed by drying yields crystallized lithium salt. Sintering of the crystallized lithium salt recovers a powder including lithium carbonate.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a process diagram of the Li recycling method;

FIG. 2 shows a process flow of a battery cathode recycling approach including Li recycling as disclosed herein; and

FIGS. 3A-3D show results of the Li recycling method using a pressurized reactor containment and an organic acid.

### DETAILED DESCRIPTION

The description below presents an example of the disclosed recycling process for lithium from a lithium rich recycling stream, such as spent EV batteries, although other suitable rechargeable battery sources may also be sourced. Batteries include cathode and anode charge materials, typically arranged in a containment including an array of cells formed by applying the charge materials to conductive sheets of current collectors, and various connectors, conductors, and casing. EVs are a particularly robust source of charge material simply due to the size of the required battery pack, whereas other uses such as cellphones, power tools and consumer devices, often strive for a smaller size. A typical EV includes about 8 kg of lithium in its battery pack.

Batteries for recycling may include not only charge material that has lost its effectiveness due to age and charging cycles, but also vehicles entering the recycling stream due to relatively new vehicles rendered unusable due to accidents, recalls, manufacturing errors and safety issues. In other words, not all the charge material is necessarily “old,” but rather enters the recycling stream from a variety of sources. Physical agitation, such as crushing and shredding, removes the physical battery casing by any suitable mechanism, where the result is a granular mass of charge material that physically stores the electric charge in the batteries.

The charge material for recycling, therefore, includes anode materials, mostly carbon and graphite, and cathode materials, typically lithium, carbon, and a mixture of transition metals defining the “battery chemistry” in a particular ratio. Anode materials may be separated by any suitable means. In the cathode recycling stream, lithium remains combined with the transition metal component, often Ni, Mn and Co (NMC) in a ratio according to the battery chemistry, although any suitable mixture of transition metals may be employed. Conventional recycling processes seek the transition metals, as these present the most lucrative recycling potential due to the expense of mining and generating virgin materials. Recent demands, however, have demonstrated the feasibility of lithium recycling. Configurations disclosed herein selectively extract the lithium from a charge material comingled with NMC, which may or may not have undergone recycling for NMC extraction. In either case, at least a residual portion of NMC remains; the approach herein extracts substantially pure lithium without contamination by residual NMC. So-called “battery grade” materials demand such high purity.

Conventional recycling employs a pyrometallurgical approach. The pyrometallurgical recycling process usually extracts target metals via a high-temperature treatment. Although it is simple and easy to scale up, lithium remains challenging to recover effectively and often remains in the slag of the process.

Leaching of lithium (Li) from spent cathode materials has emerged as an area of interest from excess yields of highly sought nickel and cobalt recycling materials. Some approaches suggest that specific acids, which enable both leaching and precipitation, along with the use of deep eutectic solvents (DES) and oxidants, can achieve targeted Li recovery from these spent, end-of-life (EOL) battery materials. For example, an organic acid such as oxalic acid has been found to selectively leach approximately 98% of Li from spent NCM cathodes. Concurrently, it promotes the formation of oxalate precipitates, which accumulate nickel (Ni), cobalt (Co), and manganese (Mn) in the solid residue. This kind of organic acid leaching reaction can form stable complexes with lithium, which can be selectively precipitated as lithium oxalate. This compound is relatively easy to filter and purify from other metal oxalates that are less soluble. Otherwise, inorganic acids typically dissolve the entire electrode material, requiring subsequent steps to separate lithium from other dissolved metals. Additionally, formic acid and its DES variant have been employed to recover Li with an efficiency of up to 99% at 70° C. within 12 hours. The use of hydrogen peroxide (H₂O₂) further enhanced the redox potential of the system, allowing for the extraction of 95.4% of Li from spent lithium iron phosphate.

Despite these advancements, most existing methods are limited to specific feedstocks, meaning they cannot be universally applied to extract lithium from all types of spent LIBs (Li-Ion Batteries), such as NMC (Nickel, Manganese, Cobalt), and LFP (Lithium Iron Phosphate) cathodes. Moreover, the use of oxidants and non-recyclable acids increases both operational costs and environmental impact, posing challenges for large-scale and sustainable lithium recovery.

Terephthalic acid (TPA) is extensively utilized in the production of polyester, plastics manufacturing, and the fabrication of engineering resins and films. Configurations disclosed below employ introduction of TPA into a highly selective lithium extraction process that achieves minimal transition metal contamination (<1%) in the extracted solution. TPA's ability to form complexes with transition metal ions stems from its two carboxylic acid groups, which can donate electrons to these ions, thereby forming coordination compounds. This specificity not only minimizes chemical waste generation but also mitigates subsequent environmental impacts. Additionally, TPA's comparatively lower toxicity than many other industrial acids simplify handling and disposal processes, thereby reducing the environmental and health risks typically associated with acid leaching processes. As a primary component in the production of polyethylene terephthalate (PET), a commonly recycled plastic, the use of TPA in lithium recovery processes is aligned with sustainable practices, thereby promoting a circular economy. The potential for TPA to be recovered and recycled within this process further enhances the sustainability of this method.

In view of the above advantages, TPA is a promising agent for the selective extraction of lithium from spent LIBs. The selectivity is primarily attributed by ion exchange of H⁺ in the TPA and Li⁺ in the cathode powder, offering a novel pathway for efficient lithium separation. To optimize the conditions for TPA extraction reaction, a comprehensive study focusing on the effect of reaction pressure, reaction time and the amount of TPA excess was conducted. This investigation aimed to establish a set of parameters that maximize the extraction efficiency, thereby enhancing the overall effectiveness of lithium recovery from spent LIBs.

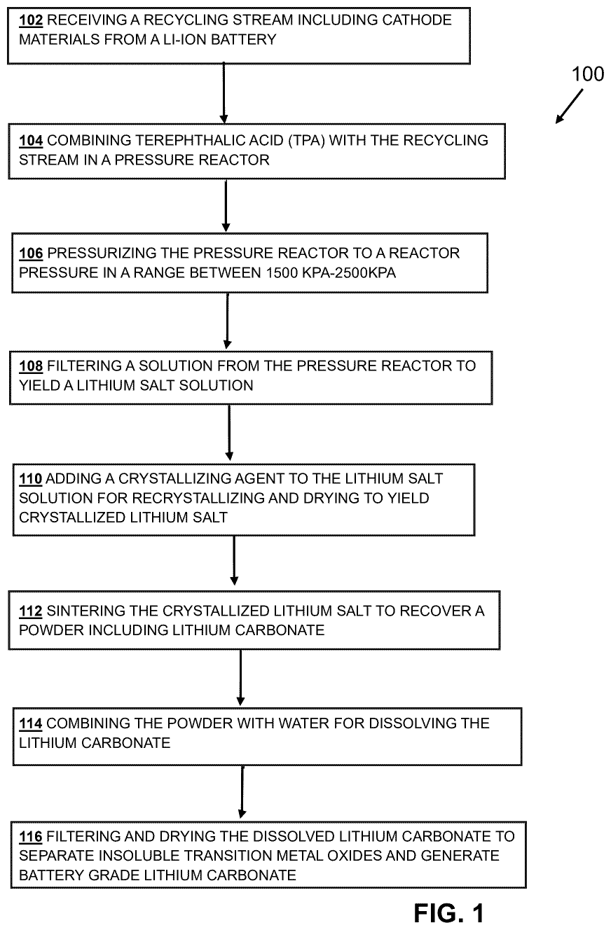

FIG. 1 is a process diagram of the Li recycling method employing organic acids such as TPA. Referring to FIG. 1, a process 100 for recycling lithium from a recycling stream including cathode materials from a li-ion battery, as depicted at step 102. Any suitable recycling stream may be employed, such as NMC (nickel, manganese, cobalt), LFP (lithium iron phosphate), LCO (lithium cobalt oxide) and LMO (lithium ion manganese). A typical recycling stream involves physical agitation, such as pulverizing and grinding the battery containments and cells into a granular mass of comingled materials, often referred to as a black mass. One particular approach for recycling batteries is disclosed in U.S. Pat. No. 9,834,827, filed Apr. 3, 2013, entitled “Method and Apparatus For Recycling Lithium-Ion Batteries” and incorporated herein by reference in entirety.

The approach of FIG. 1 introduces an organic acid-based including terephthalic acid (TPA) or 1,2,4,5-benzenetetracarboxylic acid (BTCA), or other organic acid method for highly selective lithium extraction, achieving minimal transition metal contamination (<1%) in the extracted solution. TPA combines with the recycling stream in a pressure reactor, as depicted at step 104. The reactor is pressurized to a reactor pressure in a range between 1500 kPa-3000 kPa, as disclosed at step 106. In a particular example the reaction was conducted in the hydrothermal reactor under high pressure, optimized to function at 2757 kPa (about 400 PSI) for four hours with an excess of 50% organic acid. After the pressurized extraction reaction, transition metal oxides remaining were separated with the lithium salt solution in the reactor by a simple filtration process, as shown at step 108. The transition metal oxides generally refer to the transition metals used for the particular battery chemistry, e.g. NMC, which are now separated from the Li by filtering the solution from the pressure reactor to yield the lithium salt solution.

A crystallizing agent such as acetone is added to the lithium salt solution for recrystallizing and drying to yield crystallized lithium salt, as depicted at step 110. The crystallized lithium salt is sintered to recover a powder form including lithium carbonate, as shown at step 112. In one example, after drying in a standard oven, the powder was sintered at around 600° C. for recovering lithium carbonate.

The substantially pure lithium carbonate may still have some residual charge material metals form the cathode. The post-sintering powder may be dissolved in water for purification, such that the lithium carbonate dissolves in the water, however, the impurities including transition metal oxides remain insoluble in water. Thus, the powder is combined with water for dissolving the lithium carbonate, as depicted at step 114, and the dissolved lithium carbonate is further filtered and dried to separate insoluble transition metal oxides and generate battery grade lithium carbonate, as disclosed at step 116. After this simple filtration and drying in a standard oven, the battery grade lithium carbonate yield is obtained, generally referring to a purity of at least 99.5%, with more stringent standards seeking 99.9% or even 99.999% purity.

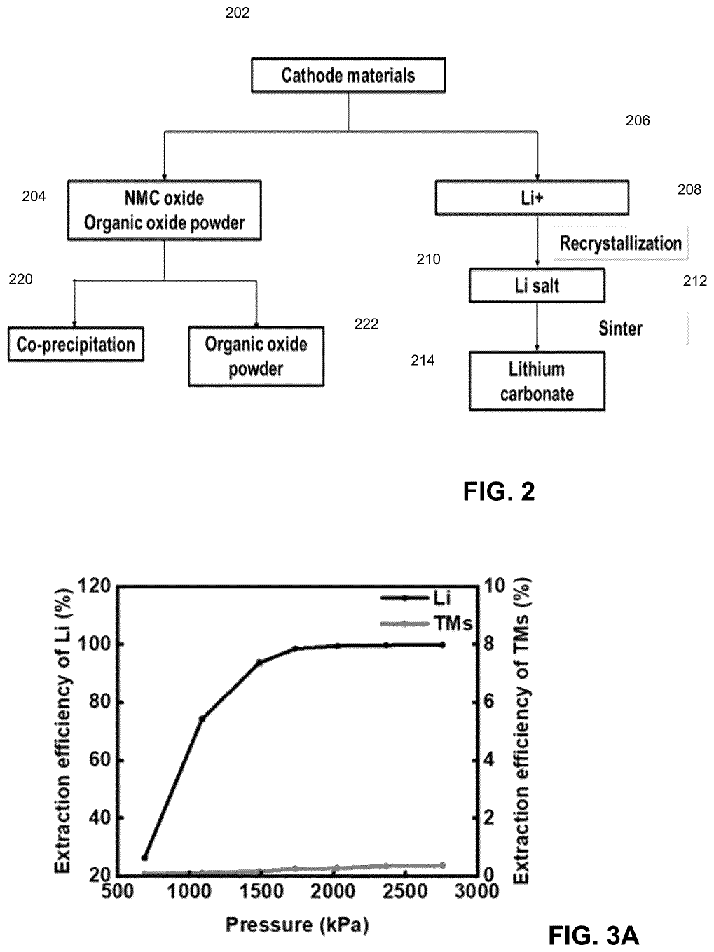

FIG. 2 shows a process flow of a battery cathode recycling approach including Li recycling as disclosed herein. Referring to FIGS. 1 and 2, configurations herein further establish a mechanism for recycling and reusing all chemicals involved through straightforward distillation, enabling a sustainable, closed-loop system for lithium recovery. This approach allows for the extraction of lithium at a 99.8% rate from various layered oxide cathode materials and an 88% extraction rate from lithium iron phosphate (LFP). Remarkably, the purity of the resultant lithium carbonate reaches up to 99.95%, with a recovery efficiency of 98.5%. Prioritizing lithium extraction from the leaching solution enhances both the recycling efficiency and the purity of the final lithium product, marking a significant advancement in lithium recovery.

The example of FIG. 2 shows the disclosed Li recycling integrated with recycling of transition metals in an NMC recycling approach, as disclosed in the US patent cited above. Referring to FIGS. 1 and 2, the cathode material stream of comingled cathode, anode, current collector and various casing materials (typically contributing iron, copper, aluminum and other trace materials and/or contaminants) provides the cathode materials 202, commencing the Li recycling approach as in step 102.

Three principal pathways for recycling EOL LIBs have been recognized: high-temperature treatment via pyrometallurgy, leaching through hydrometallurgy, and direct recycling that preserves the crystalline structure of the batteries. Pre-treatment processes, essential across all recycling methods, include steps to deactivate the batteries to reduce electrical and fire hazards and to segregate the valuable cathode materials from other components. The cathode active material, particularly Li(NiₓMn_{y}Co_{1-x-y})O₂, is sought in the recycling industry due to its rich content of valuable metals like nickel, cobalt, and lithium. Extensive research and numerous methodologies have been documented for the recovery of these metals from spent LIBs, highlighting the comprehensive efforts to address this challenge. The above cited patent addresses a hydrometallurgical approach, commencing with the NMC oxide 204 resulting from the Li leach of step 104 to form the Li+ solution 206. Recrystallization 208 yields the Li salt 210, followed by sintering 212 to form Li carbonate 214, tracking the steps of FIG. 1.

An alternate stream performs a coprecipitation of the granular NMC, and precipitates a comingled cathode material precursor of Ni, Mn and Co at step 220 and also generates other organic oxides 222 from the remainder. In an experimental configuration, Terephthalic acid (TPA), acetone, commercial lithium carbonate (Li2CO3), Dimethyl Sulfoxide (DMSO), LiNi⅓Mn⅓Co⅓O2 (NMC111, MTI), LiNi0.6Mn0.2Co0.2O2 (NMC622, Umicore), LiNi0.8Mn0.1Co0.1O2 (NMC811, MTI), LiCoO2 (LCO, MTI), LiMn2O4 (LMO, MTI), LiFePO4 (LFP, MTI), and black mass (actual spent LIB powder including mixed cathode materials, graphite, conductive carbon, commercial recycler) were used in the extraction process. All materials used in the extraction process were dissolved in an Aqua Regia to evaluate the stoichiometric ratio of the elements by inductively coupled plasma-optical emission spectrometry (ICP-OES). The results were listed in Table 1.

TABLE I

| Sample ID | Li | Ni | Mn | Co | Fe | P |
|---|---|---|---|---|---|---|
| NMC622 | 1.02 | 0.6 | 0.2 | 0.2 | — | — |
| LMO | 1.01 | — | 2 | — | — | — |
| LCO | 1.03 | — | — | 1 | — | — |
| LFP | 1.03 | — | — | — | 1.01 | 1 |
| Black mass | 0.83 | 0.21 | 0.57 | 0.22 | 0.2 wt % | — |

(it should be noted that NMC 622 refers to Ni, Mn, Co in a 60%, 20%, 20% molar ratio, respectively, NMC 811 to an 80-10-10% ratio and NMC111 refers to equal molar quantities).

The comprehensive process of recycling and recovery was depicted in FIG. 1, wherein selective extraction was executed within a hydrothermal reactor to maintain elevated temperatures and pressures. The solubility of terephthalic acid (TPA) under ambient conditions is notably low across various organic and inorganic solvents. However, the solubility can be significantly increased through the application of high pressure. During the extraction reaction, TPA dissolves in the solvent, liberating free hydrogen ions (H⁺), which subsequently engage in an ion exchange reaction with lithium (Li) present in the cathode materials within the aqueous phase, as delineated by Equation (1).

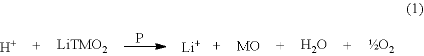

Experimental parameters, including pressure and reaction time, were varied to ascertain the optimal conditions for extraction. Following the extraction reaction, dilithium terephthalate (Li2TP), along with trace amounts of transition metal terephthalates, was dissolved in the solvent and subsequently separated via filtration. The obtained solution was transferred into acetone solution to facilitate the recrystallization of Li2TP powder. The residual substance, comprising unreacted TPA and transition metal oxides, was processed in dimethyl sulfoxide (DMSO) solution for the recycling of unreacted TPA. Using post-filtration and recrystallization in water, TPA was effectively recovered and separated from transition metal oxide residues. The Li2TP powder was sintered in the furnace to recover Li2CO3, conducted under an air atmosphere, whereby Li2TP reacted with oxygen to yield Li2CO3 and CO2 emissions. Transition metal terephthalates similarly react with oxygen, resulting in the production of metal oxides and CO2 as shown in equations 3-6.

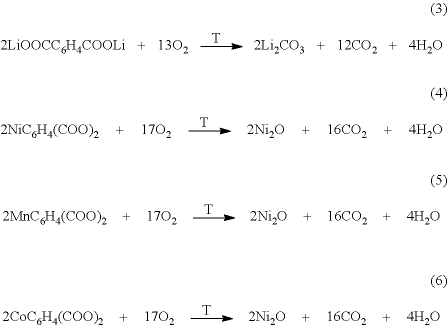

The sintering process was regulated to maintain heating rate of 5° C./min to 600° C. The sintered powder was dissolved in DI water at room temperature. After filtration, the lithium carbonate solution was obtained. This solution, upon transfer into acetone, allowed for the recrystallization of lithium carbonate. The recovered lithium carbonate powder was then washed with acetone solution during the filtration process and subsequently dried in a conventional oven. To purify the utilized acetone solution, a distillation process was employed, based on the boiling points of the involved substances.

Elemental concentrations within all leaching solutions, recycled chemicals, and end products were quantitatively assessed using Inductively Coupled Plasma Optical Emission Spectrometry (ICP-OES) to confirm efficiency and degree of purification. The crystalline structures of particles were investigated through X-ray Powder Diffraction (XRD) analysis, employing a PANalytical Empyrean system with a Cu Kα radiation source (λ=1.54 Å) and a scanning increment of 0.0167°. Scanning Electron Microscopy (SEM; JSM 7000F SEM) was utilized to evaluate the morphology and particle size. To confirm the chemical composition of the product after extraction reaction, Nuclear Magnetic Resonance (NMR) spectroscopy was performed. Thermal behavior and compositional changes of the dilithium terephthalate contaminants were examined using a Simultaneous Thermal Analyzer (SDT Q600-TA Instruments), which records both thermal transitions and mass variations in relation to temperature (or time) within a dry air environment. X-ray Photoelectron Spectroscopy (XPS) analyses were carried out on a PHI 500 VersaProbe II apparatus from Physical Electronics to elucidate the oxidation states of metallic elements on the particle surfaces, with spectral fittings processed via XPSpeak41 software. Focused ion beam (FIB) imaging and advanced scanning electron microscopy (SEM) were conducted using a Thermo Scientific Scios 2 DualBeam system for cross-section preparation and scanning images.

The electrode composition was formulated from active material (93 wt %), conductive carbon black (C65) at 4 wt %, and polyvinylidene fluoride (PVDF) binder constituting the remaining 3 wt %, all dispersed in N-methyl-2-pyrrolidone (NMP) solvent to create a homogeneous slurry. This slurry was then uniformly spread over aluminum foil using a doctor blade technique, followed by a drying phase at 80° C. for 1 hours in a conventional oven to evaporate any solvent remnants. Subsequently, the dried casting was compressed and cut into electrodes of both disc and square shapes, measuring 12 mm in diameter (for coin cells) and 57 mm by 44 mm (for single layer pouch cells), respectively. Each electrode was precisely weighed to confirm a uniform mass loading of about 18 mg/cm². Prior to assembly, these electrodes were further dried at 120° C. for 6 hours under vacuum conditions.

In a stringently controlled environment within a glove box, the assembly process for single layer pouch (SLP) cells was undertaken. This procedure included the integration of V-NMC622 and R-NMC622 cathodes, complemented by a separator, electrolyte, and anode consisting of graphite. The SLP cells underwent electrochemical performance assessments over a comprehensive range of discharge rates, from C/20 up to 2C, all within a voltage spectrum of 2.8 to 4.2 V (relative to Li/Li⁺). Whereas the cycling stability evaluations was operated at a consistent charging/discharging rate of 0.5C. These tests were conducted within a voltage parameter of 2.8 to 4.2 V, all while under standard room temperature conditions.

The above experiments, also validated below, demonstrate that TPA emerges as a promising agent for the selective extraction of lithium from spent LIBs. The selectivity is primarily attributed to the differential solubility difference of Li2TP and transition metal terephthalate, offering a novel pathway for efficient lithium separation. To investigate the optimized conditions for TPA extraction reaction, a comprehensive study focused on the effect of reaction pressure, reaction time and the amount of TPA excess. This investigation aimed to establish a set of parameters that maximize the extraction efficiency, thereby enhancing the overall effectiveness of lithium recovery from spent LIBs.

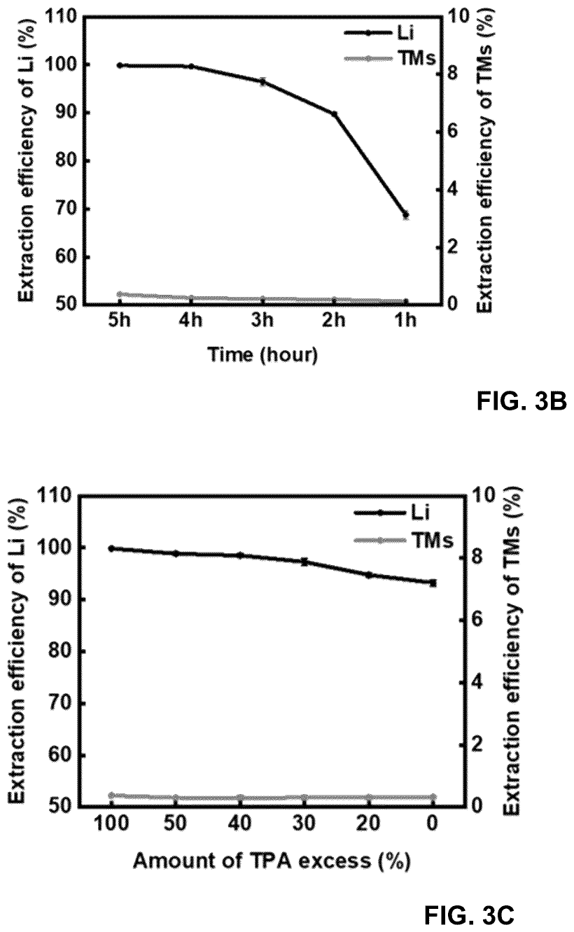

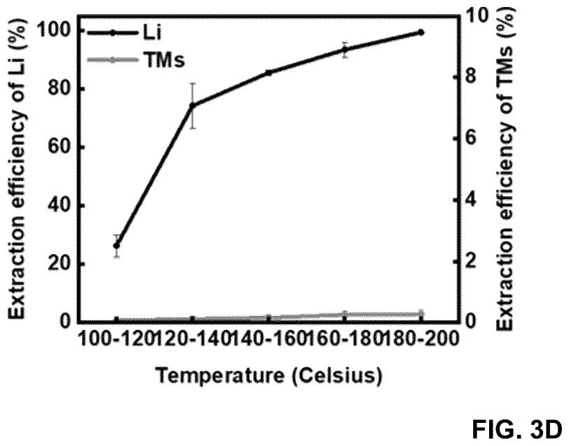

FIGS. 3A-3D show results of the Li recycling method using a pressurized reactor containment and an organic acid. In an example configuration, the method for recycling lithium from a recycling stream of Li-ion batteries includes combining cathode materials from the recycling stream with an organic acid including at least terephthalic acid (TPA) or benzenetetracarboxylic acid (BTCA), and heating the cathode materials and the organic acid under pressure to separate transition metal oxides in a lithium salt solution. Transition metal oxides are filtered from the from the lithium salt solution, and the lithium recrystallized using acetone into a powder form. Sintering the powder form recovers lithium carbonate. In particular, the pressure is around 2757 kPa and heating occurs for a duration of around 4 hours, followed by sintering at a temperature of around 600° C. for recovering the lithium carbonate. Several variations and optimizations based on the data of FIGS. 3A-3D can be observed.

For each set of extraction conditions, experiments were conducted in triplicate to determine the required reaction pressure, reaction time, and the optimal amount of TPA excess as shown in Table II for Li and transition metals (TMs). The reaction pressure was calculated based on the water's saturated vapor pressure and volumetric expansion during the reaction, with a detailed calculation methodology for pressure provided in Table III. The initial parameter optimized was the pressure; consequently, the temperature was maintained at 210° C., which was the maximum tolerance of the PTFE jar. Additionally, the reaction duration was set to 5 hours, and the TPA was used 100% excess. As shown in FIG. 3A, the average lithium extraction efficiency was only 26.14% at 685.33 kPa. However, as the pressure increased, a gradual improvement in extraction efficiency was observed, surpassing 99% at 2,025.07 kPa. This improvement is attributed to the increased solubility of TPA under higher pressure, supported by morphological changes in TPA crystals from cubic to needle-like structures, indicating dissolution in the solvent. At higher pressures, the extraction efficiency remained stable, achieving 99.53% at 2,363.6 kPa and 99.84% at 2,757.13 kPa. Notably, the efficiency of transition metal extraction was consistently below 0.5%, demonstrating the process's high selectivity for lithium due to the low solubility of transition metal terephthalates.

TABLE II

| Pressure | Li | TMs | Time | Li | TMs | TPA% | Li | TMs |
|---|---|---|---|---|---|---|---|---|
| 685.325 | 26.14 | 0.09 | 5 h | 99.84 | 0.36 | 100% | 99.84 | 0.36 |
| | 25.31 | 0.05 | | 100 | 0.38 | | 100 | 0.38 |
| | 27.52 | 0.1 | | 99.71 | 0.37 | | 99.71 | 0.37 |
| Mean | 26.32 | 0.08 | Mean | 99.85 | 0.37 | Mean | 99.85 | 0.37 |
| Standard | 0.79 | 0.02 | Standard | 0.10 | 0.01 | Standard | 0.10 | 0.01 |
| Deviation | | | Deviation | | | Deviation | | |
| 1085.95 | 74.76 | 0.12 | 4 h | 99.64 | 0.23 | 50% | 99.01 | 0.31 |
| | 73.21 | 0.1 | | 99.81 | 0.3 | | 98.35 | 0.26 |
| | 75.03 | 0.13 | | 99.53 | 0.2 | | 99.21 | 0.33 |
| Mean | 74.33 | 0.12 | Mean | 99.66 | 0.24 | Mean | 98.86 | 0.30 |
| Standard | 0.69 | 0.01 | Standard | 0.10 | 0.04 | Standard | 0.32 | 0.03 |
| Deviation | | | Deviation | | | Deviation | | |
| 1483.01 | 93.01 | 0.18 | 3 h | 96.44 | 0.2 | 40% | 98.53 | 0.3 |
| | 92.53 | 0.16 | | 95.31 | 0.18 | | 98.02 | 0.2 |
| | 95.21 | 0.14 | | 97.62 | 0.26 | | 99.01 | 0.4 |
| Mean | 93.58 | 0.16 | Mean | 96.46 | 0.21 | Mean | 98.52 | 0.30 |
| Standard | 1.01 | 0.01 | Standard | 0.82 | 0.03 | Standard | 0.35 | 0.07 |
| Deviation | | | Deviation | | | Deviation | | |
| 1732.54 | 98.96 | 0.27 | 2 h | 89.98 | 0.19 | 30% | 97.5 | 0.31 |
| | 97.53 | 0.21 | | 89.03 | 0.15 | | 96.31 | 0.21 |
| | 99.02 | 0.3 | | 90.16 | 0.23 | | 98.05 | 0.4 |
| Mean | 98.50 | 0.26 | Mean | 89.72 | 0.19 | Mean | 97.29 | 0.31 |
| Standard | 0.60 | 0.03 | Standard | 0.43 | 0.03 | Standard | 0.63 | 0.07 |
| Deviation | | | Deviation | | | Deviation | | |
| 2025.07 | 99.35 | 0.27 | 1 h | 69.85 | 0.16 | 20% | 94.94 | 0.32 |
| | 100 | 0.35 | | 67.23 | 0.1 | | 94.01 | 0.21 |
| | 99.01 | 0.21 | | 69.16 | 0.12 | | 95.34 | 0.4 |
| Mean | 99.45 | 0.28 | Mean | 68.75 | 0.13 | Mean | 94.76 | 0.31 |
| Standard | 0.36 | 0.05 | Standard | 0.96 | 0.02 | Standard | 0.48 | 0.07 |
| Deviation | | | Deviation | | | Deviation | | |
| 2363.6 | 99.53 | 0.31 | | | | 0% | 93.36 | 0.35 |
| | 100 | 0.38 | | | | | 92.34 | 0.25 |
| | 99.61 | 0.35 | | | | | 94.01 | 0.36 |
| Mean | 99.71 | 0.35 | | | | Mean | 93.24 | 0.32 |
| Standard | 0.18 | 0.02 | | | | Standard | 0.60 | 0.04 |
| Deviation | | | | | | Deviation | | |
| 2757.13 | 99.84 | 0.36 | | | | | | |
| | 100 | 0.38 | | | | | | |
| | 99.71 | 0.37 | | | | | | |
| Mean | 99.85 | 0.37 | | | | | | |
| Standard | 0.10 | 0.01 | | | | | | |
| Deviation | | | | | | | | |

To enhance resource utilization in the TPA extraction process, reaction time and TPA excess were optimized. Referring to FIG. 3B, A 4-hour reaction time maintained a high extraction efficiency of 99.84%, whereas shorter reaction times resulted in diminishing efficiencies: 96.44% at 3 hours, 86.98% at 2 hours, and 69.85% at 1 hour. Concurrently, shorter reaction times correlated with increased transition metal extraction, underscoring the need for a 4-hour reaction to maximize lithium recovery while maintaining selectivity. Similarly, the optimal TPA excess was determined. As illustrated in FIG. 3C, the lithium extraction efficiency was 93.36% with no TPA excess. Efficiency increased with higher TPA excess and stabilized at 99.84% with a 50% excess, while transition metal extraction remained below 0.36%. Additional TPA excess did not further improve lithium extraction efficiency, establishing 50% TPA excess as optimal. Furthermore, the reaction temperature was optimized to balance extraction efficiency with reduced energy consumption. Referring to FIG. 3D, extraction efficiency achieved a high of 99.45±0.36% within the temperature range of 180° C. to 200° C. A decrease in reaction temperature correspondingly led to a reduction in extraction efficiency. Consequently, the optimal temperature range for the extraction process was established as 180° C. to 200° C.

TABLE III

| | saturated vapor | Volume | Total |
|---|---|---|---|
| temperature | pressure | expansion | pressure |
| T1 | 198.97 | 486.36 | 685.33 |
| T2 | 478 | 607.95 | 1085.95 |
| T3 | 794 | 689.01 | 1483.01 |
| T4 | 1003 | 729.54 | 1732.54 |
| T5 | 1255 | 770.07 | 2025.07 |
| T6 | 1553 | 810.6 | 2363.60 |
| T7 | 1906 | 851.13 | 2757.13 |

Given the diversity of materials encountered in recycling operations, the universality of the TPA extraction process was evaluated for various cathode compositions, including LMO, LCO, LFP, and black mass (a mixture of NMC111, LMO, graphite anode, and conductive carbon). SEM images reveal a reduction in particle size for LCO, LMO, and LFP compared to pristine samples. Additionally, distinct needle-shaped TPA crystals are evident in these SEM images, highlighting the morphological changes induced during the extraction process. X-ray diffraction (XRD) analysis was subsequently performed on the residue powders to further elucidate their composition. XRD patterns display prominent peaks of TPA, indicating its presence across the powders of extracted-LMO, extracted-LCO, and extracted-LFP. The residue powders were identified as FePO₄ in extracted-LFP, Co₃O₄ in extracted-LCO, and Mn₂O₃ in extracted-LMO, indicating a high extraction efficiency of LMO, LCO, and LFP via TPA. Under optimized conditions, the lithium extraction efficiencies were as follows: For LCO, 95.17% with a 0.52% extraction efficiency for Co as an impurity in the leaching solution. The efficiency for LMO reached 99.63%, with Mn impurity at only 0.47%. For LFP, the lithium extraction was slightly lower at 94.75%, accompanied by 0.10% of P and 0.13% of Fe impurities. The leaching efficiency for black mass (BM) was 96.63%, with impurities of 0.12% Ni, 0.31% Mn, and 0.17% Co in the solution. To further improve extraction efficiency for LCO, LFP, and black mass, the reaction time was extended to 6 hours. Under these adjusted conditions, the extraction efficiencies were as follows: 98.71% for LCO, 99.66% for LMO, 98.53% for LFP, and 99.81% for black mass. The impurity leaching efficiencies were 0.61% for Co from LCO, 0.48% for Mn from LMO, 0.33% for LFP (comprising 0.15% P and 0.18% Fe), and 0.65% for black mass (with 0.15% Ni, 0.33% Mn, and 0.17% Co). Overall, this study developed a universal lithium extraction method capable of selectively recovering lithium from diverse feedstocks with extraction efficiencies exceeding 98.5% while minimizing impurity leaching. The disclosed approach provides a universal and sustainable solution for lithium recovery from spent LIBs.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for recycling lithium from a recycling stream of batteries, comprising:
receiving a recycling stream including cathode materials from a li-ion battery;
combining terephthalic acid (TPA) with the recycling stream in a pressure reactor;
pressurizing the pressure reactor to a reactor pressure in a range between 1500 kPa-3000 kPa;
filtering a solution from the pressure reactor to yield a lithium salt solution;
adding a crystallizing agent to the lithium salt solution for recrystallizing and drying to yield crystallized lithium salt; and
sintering the crystallized lithium salt to recover a powder including lithium carbonate.

2. The method of claim 1 further comprising:
combining the powder with water for dissolving the lithium carbonate; and
filtering and drying the dissolved lithium carbonate to separate insoluble transition metal oxides and generate battery grade lithium carbonate.

3. The method of claim 1 wherein the reactor pressure is substantially around 2757 kPa and maintained for four hours.

4. The method of claim 1 further comprising maintaining the pressure for between 2-4 hours for achieving an extraction efficiency of at least 86.98% of the lithium in the recycling stream.

5. The method of claim 1 wherein the reactor pressure is between 2025.07 kPa and 2757.13% kPa and achieves an extraction efficiency of at least 99% of the lithium in the recycling stream.

6. The method of claim 1 further comprising combining the terephthalic acid (TPA) based on an amount of the lithium in the recycling stream.

7. The method of claim 1 further comprising combining the terephthalic acid (TPA) in an excess of 50% of an amount for combining with the lithium in the recycling stream.

8. The method of claim 1 wherein the crystallizing agent is acetone.

9. The method of claim 1 further comprising heating the pressure reactor to at least 120° C.

10. The method of claim 1 further comprising heating the pressure reactor to a range between 180° C. and 200° C. during the pressurizing.

11. The method of claim 1 wherein the recycling stream is sourced from Ni, Mn, Co (NMC) batteries.

12. The method of claim 11 further comprising:
agitating a stream of NMC batteries to generate a granular black mass, the black mass including dismantled anode, cathode and current collector materials; and
providing the black mass as the recycling stream.

13. The method of claim 1 wherein the recycling stream is sourced from battery chemistries selected from the group consisting of NMC (nickel, manganese, cobalt), LFP (lithium iron phosphate), LCO (lithium cobalt oxide) and LMO (lithium ion manganese).

14. A method for recycling lithium from a recycling stream of Li-ion batteries, comprising:
combining cathode materials from the recycling stream with an organic acid including at least terephthalic acid (TPA) or benzenetetracarboxylic acid (BTCA);
heating the cathode materials and the organic acid under pressure to separate transition metal oxides from a lithium salt solution;
filtering the transition metal oxides from the lithium salt solution;
recrystallizing the lithium salt solution to a powder form; and
sintering the powder form to recover lithium carbonate.

15. The method of claim 1 wherein the pressure is around 2757 kPa and heating occurs for a duration of around 4 hours, followed by sintering at a temperature of around 600° C. for recovering lithium carbonate.
